(19) United States
(12) Patent Application Publication
(10) Pub. No.: US 2026/0289845 A1
(43) Pub. Date: Sep. 24, 2026

(54) Systems And Methods For Image Manipulation Based On Natural Language Manipulation Instructions

(71) Applicant: Google LLC, Mountain View, CA (US)

(72) Inventor: Myungsub Choi, Seoul (KR)

(21) Appl. No.: 18/873,289

(22) PCT Filed: Jun. 8, 2022
(86) PCT No.: PCT/US2022/032612

§ 371 Date: Dec. 9, 2024

(51) Int. Cl. G06T 11/60; G06T 5/77; G06T 7/11

(52) U.S. Cl. CPC G06T 11/60; G06T 5/77; G06T 7/11

(57) ABSTRACT

Provided are computer systems and methods for image manipulation based on natural language manipulation instructions. In particular, the present disclosure introduces an entirely new problem space of referring object manipulation (ROM). In ROM, a computer system aims to generate photo-realistic image edits regarding two textual descriptions: 1) a reference text referring to an object in the input image and 2) a target text describing how to manipulate the referred object. The successful ROM models described herein enable users to simply use natural language to manipulate images, removing the need for learning sophisticated image editing software.

### FIELD

The present disclosure relates generally to machine learning. More particularly, the present disclosure relates to computer systems and methods for image manipulation based on natural language manipulation instructions.

### BACKGROUND

With the increase in the production and consumption of digital content by both professionals and amateurs, there is an increased need for easy-to-use image and/or video editing tools. However, existing tools such as professional image editing tools usually require complex software and/or professional knowledge of editing techniques. To allow image editing to be more accessible to diverse user groups, recent works are beginning to explore image manipulation with natural language, which can serve as a highly intuitive user interface.

Recently, the combination of large-scale vision-language models and high-quality generative models has led to interesting new text-driven applications, including text-guided image manipulation and out-of-domain image translation. However, previous methods typically modify the image globally, and fine-grained control of specific objects is not possible. A number of recent methods also allow the user to provide a segmentation mask as an additional input, so that users can specify the regions for text-guided inpainting. While enabling submission of a user-defined mask is a convenient interface for image editing, it still requires the users to draw a high quality mask that fully covers the regions of interest.

### SUMMARY

Aspects and advantages of embodiments of the present disclosure will be set forth in part in the following description, or can be learned from the description, or can be learned through practice of the embodiments.

One example aspect of the present disclosure is directed to a computer system for image manipulation. The computer system includes one or more processors. The computer system includes a machine-learned image manipulation model configured to receive and process an input image and a natural language instruction to generate an edited image in accordance with the natural language instruction, wherein the natural language instruction comprises a reference portion that refers to a region of the input image and a target portion that describes a desired manipulation to be performed in the region of the input image. The computer system includes one or more non-transitory computer-readable media that collectively store instructions that, when executed by the one or more processors, cause the one or more processors to perform operations. The operations include obtaining the input image and the natural language instruction; processing the input image and the natural language instruction with the machine-learned image manipulation model to generate the edited image, wherein the desired manipulation has been performed in the region of the input image to generate the edited image; and providing the edited image as an output.

Another example aspect of the present disclosure is directed to a computer-implemented method for image manipulation. The method includes obtaining, by a computing system comprising one or more computing devices, an input image and a natural language instruction, wherein the natural language instruction comprises a reference portion that refers to a region of the input image and a target portion that describes a desired manipulation to be performed in the region of the input image; processing, by the computing system, the input image and the natural language instruction with a machine-learned image manipulation model to generate an edited image, wherein the desired manipulation has been performed in the region of the input image to generate the edited image; and providing, by the computing system, the edited image as an output.

Another example aspect of the present disclosure is directed to one or more non-transitory computer-readable media that collectively store: a machine-learned image manipulation model configured to receive and process an input image and a natural language instruction to generate an edited image in accordance with the natural language instruction, wherein the natural language instruction comprises a reference portion that refers to a region of the input image and a target portion that describes a desired manipulation to be performed in the region of the input image; and instructions that, when executed by one or more processors, cause the one or more processors to perform operations, the operations comprising: obtaining the input image and the natural language instruction; processing the input image and the natural language instruction with the machine-learned image manipulation model to generate the edited image, wherein the desired manipulation has been performed in the region of the input image to generate the edited image; and providing the edited image as an output.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a diagram of an example referring object manipulation problem setting according to example embodiments of the present disclosure.

FIG. 2 depicts a graphical diagram of an example model architecture for performing referring object manipulation according to example embodiments of the present disclosure.

FIG. 3 depicts a graphical diagram of performing conditional classifier-free guidance according to example embodiments of the present disclosure.

FIGS. 4-8 depict example experimental results according to example embodiments of the present disclosure.

FIG. 9A depicts a block diagram of an example computing system according to example embodiments of the present disclosure.

FIG. 9B depicts a block diagram of an example computing device according to example embodiments of the present disclosure.

FIG. 9C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to computer systems and methods for image manipulation based on natural language manipulation instructions. In particular, the present disclosure introduces an entirely new problem space and task that can be called “referring object manipulation” (ROM). In ROM, a computer system aims to generate photo-realistic image edits on the basis of two textual descriptions: 1) a reference text referring to an object in the input image and 2) a target text describing how to manipulate the referred object. The present disclosure provides machine learning models that perform the ROM task. In particular, the successful ROM models described herein enable users to simply use natural language to manipulate images, removing the need for learning sophisticated image editing software. The present disclosure provides the first approach to address this challenging multi-modal problem by combining a referring image segmentation method with a text-guided diffusion model. Specifically, one example aspect of the present disclosure includes a conditional classifier-free guidance scheme to better guide the diffusion process along the direction from the referring expression to the target prompt. In addition, another example aspect provides a new localized ranking method and further improvements to make the generated edits more robust. Experimental results show that the proposed framework can serve as a simple but strong baseline for referring object manipulation. Also, comparisons with several baseline text-guided diffusion models demonstrated the effectiveness of our improved conditional classifier-free guidance.

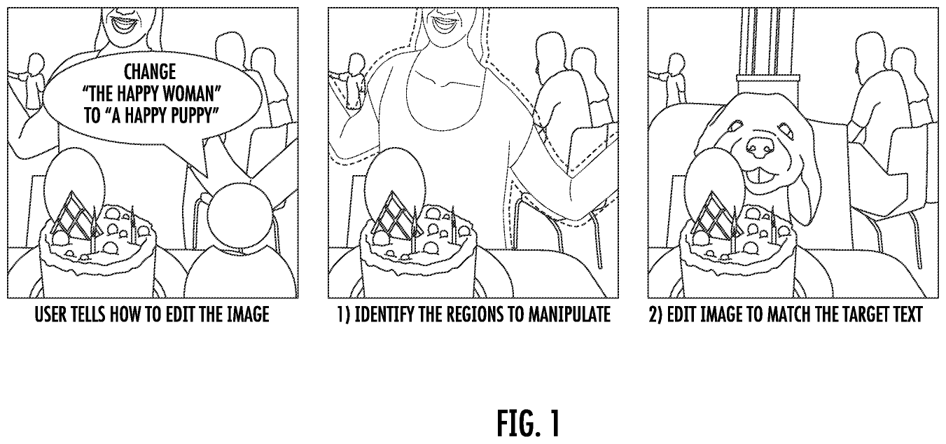

More particularly, the present disclosure introduces the new problem of referring object manipulation, which can provide a fully automatic user interface of image editing with natural language. The goal of this task is to generate photo-realistic image edits that follow the target text description, given an input image and a text referring to a specific region in the image. The edited output image should be different from the input image only in the referred regions, and the intended modifications should correctly reflect the attributes described in the target text. The main concept of the proposed problem setting is illustrated in FIG. 1.

Specifically, FIG. 1 shows the referring object manipulation problem setting. Given an image, a referring text prompt that describes which region to edit, and a target text prompt describing how to modify the specified region, the goal of the system is to generate a photo-realistic edited image that results from effecting the instructions contained in all (both referring and target) textual descriptions.

To address this challenging problem for the first time, the present disclosure provides a simple baseline framework that combines a referring object segmentation model with text-guided image manipulation or inpainting model. In particular, some example implementations can leverage the pretrained models of MDETR and GLIDE for localizing the referring object and editing the region with textual guidance, respectively. MDETR is described at Kamath et al., Mdetrmodulated detection for end-to-end multi-modal understanding. In: ICCV (2021). GLIDE is described at Nichol et al., Glide: Towards photorealistic image generation and editing with text-guided diffusion models. arXiv: 2112.10741 (2021)

While sequential combination of the two models shows plausible result, the present disclosure provides a number of additional techniques for improvement, including: 1) a new conditional classifier-free guidance for better guiding the generation process in the inpainting stage, 2) localized ranking of multiple generations, and 3) dilation of the intermediate segmentation mask. Note that the proposed techniques still shows significant improvements even without any additional training or fine-tuning of the pretrained model parameters. Experimental results and analyses demonstrate the effectiveness of the proposed framework, both qualitatively and quantitatively with a user study.

Thus, the present disclosure introduces a new problem of referring object manipulation and proposes an effective baseline framework. The present disclosure also provides conditional classifier-free guidance for improved manipulation of local image regions using a text-guided diffusion model. In addition the proposed framework generates the most favorable image edits qualitatively and outperforms all compared baselines.

The systems and methods of the present disclosure provide a number of technical effects and benefits. As one example, the provided techniques enable more efficient image manipulation. Thus, rather than using a complex image editing tool, users can simply provide a natural language instruction to the proposed system. This can result in faster editing or manipulation of imagery. By enabling faster manipulation of imagery, less time can be spent performing image editing within a software-based image editing program. This can reduce the consumption of computational resources such as processor, memory, and/or network bandwidth usage. In addition, the proposed techniques improve the ability of a computer to manipulate imagery. For example, the proposed context-aware ranking can provide for generation of images that are more semantically consistent. Thus, the proposed techniques improve the performance of a computer itself.

With reference now to the Figures, example embodiments of the present disclosure will be discussed in further detail.

### Example Guided Diffusion Techniques

This section briefly reviews a series of developments in guided diffusion models: the baseline diffusion model, classifier guidance, classifier-free guidance, and CLIP guidance. This line of work informs the fundamentals of the proposed classifier-free guidance technique and are all compared in the experiments.

### Example Description of Diffusion Models

Given a sample from the real data distribution x₀~q(x₀), a diffusion process generates a Markov chain of latent variables x₁, . . . , x_{T} by adding Gaussian noise at each timestep t:

$$q ( {x}_{t} \vert {x}_{t - 1} ) := 𝒩 ( {x}_{t} ; \sqrt{1 - {β}_{t}} {x}_{t - 1} , {β}_{t} 𝒥 ) , \qquad ( 1 )$$

where the amount of noise is controlled by a variance schedule

$${\{ {β}_{t} ∈ ( 0 , 1 ) \}}_{t = 1}^{T} .$$

It is known that if βₜ is small enough, the posterior q(xₜ₋₁|xₜ) can be approximated by a diagonal Gaussian, and that the final variable x_{T} approximately follows [symbol] (0, [symbol] ) with sufficiently large amount of total noise added. Since calculating the true posterior q(xₜ₋₁|xₜ) is infeasible, an approximate model p_{θ} needs to be learned as follows:

$${p}_{θ} ( {x}_{t - 1} \vert {x}_{t} ) := 𝒩 ( {μ}_{θ} ( {x}_{t} ) , {\sum }_{θ} ( {x}_{t} ) ) . \qquad ( 2 )$$

Then, sample generation can be done by starting with a random Gaussian noise x_{T}~ [symbol] (0, [symbol] ) and sequentially sampling x_{T-1}, . . . , x₀ using the learned model. In practice, a reparameterization trick can be used to decompose the latent variable xₜ into a mixture of signal x₀ and some additive noise ε, which is estimated by a noise approximation model ε_{θ}(xₜ, t). The values for μ_{θ}(xₜ) can also be derived as a function of ε_{θ}(xₜ, t) and Σ_{θ} can be fixed to a constant. In addition, instead of calculating the actual variational lower-bound on log p_{θ}(x₀), a simplified mean-square error objective, which is known to work better in practice, can be used:

$${L}_{simple} := {E}_{t ∼ [ 1 , T ] , {x}_{0} ∼ q ( {x}_{0} ) , ε ∼ 𝒩 ( 0 , I )} [ {‖ ε - {ε}_{θ} ( {x}_{t} , t ) ‖}^{2} . \qquad ( 3 )$$

Training with this objective and the sampling procedure is equivalent to the denoising score-matching based models. In some example implementations of the present disclosure, the GLIDE model can be used, which adopts a follow-up method that makes Σ_{θ} learnable and produce better samples with fewer diffusion steps.

### Example Description of Guided Diffusion

Class-conditional diffusion models can generate better samples with classifier guidance. Concretely, the mean μ_{θ}(xₜ|y) and variance Σ_{θ}(xₜ|y) of the diffusion model can be perturbed by the gradient of the log-likelihood log p_{φ}(y|xₜ) of an auxiliary classifier for a target class y. The resulting new perturbed mean \hat{μ}_{θ}(xₜ|y) can then be calculated as:

$${\hat{μ}}_{θ} ( {x}_{t} \vert y ) = {μ}_{θ} ( {x}_{t} \vert y ) + s \cdot {\sum }_{θ} ( {x}_{t} \vert y ) {∇}_{{x}_{t}} log {p}_{ϕ} ( y \vert {x}_{t} ) , \qquad ( 4 )$$

where the coefficient s is a guidance scale that controls the trade-off between sample quality and diversity (higher s gives better quality with less diversity). One downside of classifier guidance is that it requires a separate classifier which needs to be explicitly trained on noisy input images (to simulate the latent variables xₜ). This introduces notable additional complexity, since the standard pretrained classifiers (trained on clean images) cannot be used.

### Example Description of Classifier-Free Guidance

Classifier-free guidance removes the need for a separately trained classification model. Specifically, when training a class-conditional diffusion model ε_{θ}(xₜ|y), the class label y is randomly replaced with a null label Ø with a fixed probability (denoted as an unconditional model, ε_{θ}(xₜ|Ø). Sampling is done by a linear combination of the conditional and unconditional model estimates:

$${\hat{ε}}_{θ} ( {x}_{t} \vert y ) = {ε}_{θ} ( {x}_{t} \vert ∅ ) + s \cdot ( {ε}_{θ} ( {x}_{t} \vert y ) - {ε}_{θ} ( {x}_{t} \vert ∅ ) ) , \qquad ( 5 )$$

where s≥1 is the guidance scale. Intuitively, classifier-free guidance further extrapolates the output of the model (noise part) along the direction of ε_{θ}(xₜ|y), moving away from ε_{θ}(xₜ|Ø).

GLIDE used classifier-free guidance with generic text prompts, which is implemented by randomly replacing the text captions with an empty sequence (also referred as Ø) during training. The generative process can then be guided towards the caption c as

$${\hat{ε}}_{θ} ( {x}_{t} \vert c ) = {ε}_{θ} ( {x}_{t} \vert ∅ ) + s \cdot ( {ε}_{θ} ( {x}_{t} \vert c ) - {ε}_{θ} ( {x}_{t} \vert ∅ ) ) . \qquad ( 6 )$$

Classifier-free guidance can be thought of a self-supervised way of leveraging the learned knowledge of a single diffusion model. Some example implementations of the present disclosure extend this approach to give better guidance direction when applied to a referring object manipulation problem.

### Example Description of CLIP Guidance

CLIP is a method of learning joint image-text representation. CLIP is described at Radford et al.: Learning transferable visual models from natural language supervision. arXiv: 2103.00020 (2021). The model consists of an image encoder f(x) and a caption encoder g(c), which is trained with a contrastive loss that encourages a high dot product for the matching image (x)-text (c) pairs and low values otherwise.

Since CLIP provides a way of measuring the semantic distance between an image and a caption, some previous works use it for designing text-guided image manipulation models using the state-of-the-art GANs. More recently, the same idea is applied to diffusion models, where the noisy classifier of classifier guidance (Eq. (4)) is replaced with a CLIP model:

$${\hat{μ}}_{θ} ( {x}_{t} \vert c ) = {μ}_{θ} ( {x}_{t} \vert c ) + s \cdot {\sum }_{θ} ( {x}_{t} \vert c ) {∇}_{{x}_{t}} ( f ( {x}_{t} ) \cdot g ( c ) ) . \qquad ( 7 )$$

### Example Image Manipulation Techniques

### Example Description of Problem Setting

The present disclosure introduces a new problem of Referring Object Manipulation, which aims to modify the referring region of interest from an input image to conform to the target text expression. Specifically, a referring object manipulation model has three inputs: an input image I, a referring text prompt c_{ref}, and a target text prompt c_{target}. The output is an edited image Ĩ, which should successfully contain the attributes described in the target text.

To achieve this goal, a model should first be able to correctly infer the local regions where c_{ref} is referring to, and then manipulate the regions according to the target c_{target}. This is a challenging task that requires full multi-modal (vision and language) understanding and high-quality generative models. The conceptual illustration is shown in FIG. 1.

According to an aspect of the present disclosure, in some implementations, referring object manipulation problem can be decomposed into two sub-problems, referring image segmentation and text-guided image inpainting. A referring image segmentation model can estimate a precise segmentation mask M, given an input image I and a referring prompt c_{ref}. On the other hand, a text-guided image inpainting models can generate a photo-realistic edited image I given an input image I, a mask specifying the regions to edit, and a target prompt c_{target}. Therefore, by providing the automatically generated mask M as input to the inpainting model, an end-to-end framework for referring object manipulation can be built.

With recent developments in both fields (referring segmentation and text-guided inpainting), a sequential combination of two models serves as a simple but strong baseline. However, due to the different focus and the evaluation metrics in each field, there are some cases when the errors from an earlier model propagates and generates visually unpleasing outputs. The following subsections provide novel solutions to make the generations more robust.

### Example Model Architectures

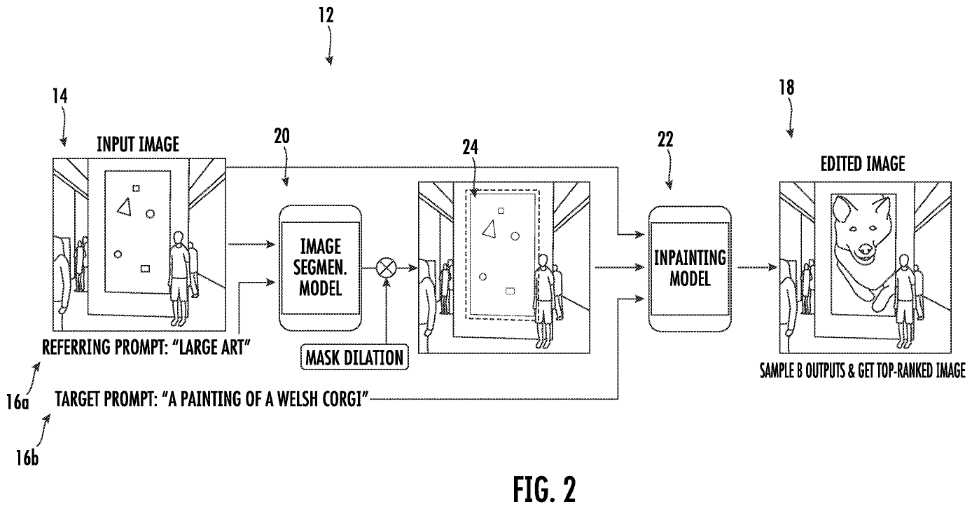

FIG. 2 provides a graphical diagram of an example model architecture for image manipulation. Specifically, FIG. 2 shows an example machine-learned image manipulation model 12 configured to receive and process an input image 14 and a natural language instruction 16a-b to generate an edited image 18 in accordance with the natural language instruction 16a-b. In particular, the natural language instruction 16a-b comprises a reference portion 16a that refers to a region of the input image 14 and a target portion 16b that describes a desired manipulation to be performed in the region of the input image 14.

More specifically, in the example model 12 shown in FIG. 2 includes a machine-learned image segmentation model 20 and a machine-learned inpainting model 22. The machine-learned image segmentation model 20 is configured to receive and process the input image 14 and the reference portion 16a of the natural language instruction to generate an image mask 24 that identifies the region of the input image 14 referenced by the reference portion 16a of the natural language instruction.

The machine-learned inpainting model 22 is configured to receive and process the input image 12, the image mask 24, and the target portion 16b of the natural language instruction to generate the edited image 18. In some implementations, the machine-learned inpainting model 22 comprises a conditional diffusion model.

In some example implementations, as shown in FIG. 2, the model 12 or associated computing system can dilate the image mask 24 prior to processing the input image 14, the image mask 24, and the target portion 16b of the natural language instruction with the machine-learned inpainting model 22. This can result in an improved mask 24 which does not fail to capture small details at the edge of a masked region or object.

According to another aspect, in some implementations, the machine-learned inpainting model 22 can be provided with conditional classifier-free guidance during generation of the edited image. For example, the conditional classifier-free guidance can guide the generation of the edited image 18 toward the target portion 16b of the natural language instruction from the reference portion 16a of the natural language instruction. In some examples, the machine-learned inpainting model 22 can be a diffusion model and the conditional classifier-free guidance can perturb additive noise of the diffusion model based on a probability associated with the reference portion 16a of the natural language instruction.

In some implementations, one or both of the machine-learned image segmentation model 20 and the machine-learned inpainting model 22 are pretrained.

In some implementations, multiple candidate outputs (e.g., B candidate outputs) can be sampled from the inpainting model 22 and a selection process can be performed to select a final output as the edited image 18. Thus, in some implementations, processing the input image 14 and the natural language instruction 16a-b with the machine-learned image manipulation model 12 to generate the edited image 18 can include: processing, for a plurality of instances, the input image 14 and the natural language instruction 16a-b with the machine-learned image manipulation model 12 (e.g., using all of the model 12 or only the second stage (model 22)) to generate a plurality of candidate images; generating a respective semantic similarity score for at least a portion of each of the plurality of candidate images relative to at least the target portion 16b of the natural language instruction; and selecting one of the candidate images to output as the edited image 18 based at least in part the respective semantic similarity scores. For example, generating the respective semantic similarity score for at least the portion of each of the plurality of candidate images can include generating the respective semantic similarity score for a respective context-aware bounding box generated for each of the plurality of candidate images. For example, the respective context-aware bounding box for each of the plurality of candidate images can be defined by enlarging by an enlargement factor a bounding box that includes the region of the input image 14.

Thus, in some implementations, an image segmentation model 20 first estimates the referred-to segmentation mask 24 given the input image 14 and the referring text prompt 16a. Then, using the input image 14, the dilated segmentation mask 24, and the target text prompt 16b, an inpainting model 22 edits the masked regions 24 to correctly follow the target prompt 16b. In some implementations, multiple candidate images (e.g., B=24) are generated and the final output can be decided to be the top-ranked image with respect to a ranking scheme.

One example realization of the referring object manipulation framework described above combines two state-of-the-art models in each area: MDETR for referring image segmentation and GLIDE for text-guided image inpainting.

MDETR is a Transformer-based text-modulated detection system that can localize a specific region of an image given a referring textual expression. In practice, some example implementations of the present disclosure use an extended version of MDETR fine-tuned on PhraseCut dataset, which can not only predict the object bounding boxes but can also generate pixel-level segmentation masks. PhraseCut is described at Wu et al., Phrasecut: Language-based image segmentation in the wild. In: CVPR (2020).

GLIDE is a large-scale image generation and editing framework based on conditional diffusion models. Some example implementations of the present disclosure use the model specifically trained to perform image inpainting; in particular, the smaller open-sourced version that is trained with a filtered dataset can be used. The filtered dataset aims to remove any potential bias in the data and pretrained models.

A simple combination of MDETR and GLIDE can occasionally generate impressive output edits, but provided herein are a number of additional improvements for more reliable manipulation, including: conditional classifier-free guidance, context-aware localized output ranking, and mask dilation. Each new component will be described in detail in the following sections.

Some example implementations can use the pretrained models from MDETR and GLIDE as is, without any further training or fine-tuning. Also, any referring object segmentation model can be substituted instead of MDETR, and any conditional diffusion model can be substituted instead of GLIDE, for example the model can be trained with the inpainting setting with a mask input.

### Example Conditional Classifier-Free Guidance

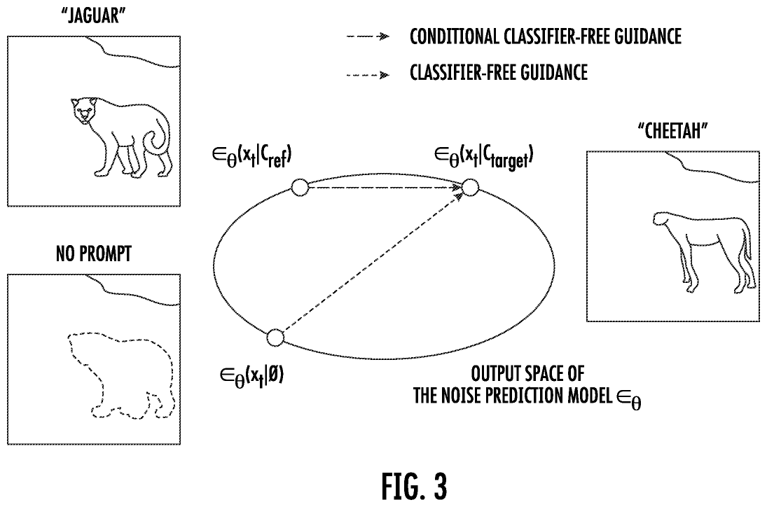

FIG. 3 provides a conceptual illustration of the conditional classifier-free guidance approach proposed by the present disclosure. Specifically, while the original classifier-free (CF) guidance can be thought of guiding the denoising generative process from no input prompt, the proposed conditional CF guidance starts from the referring prompt and can make the manipulation (empirically) easier on the noise prediction space ¿e.

More particularly, example aspects of the present disclosure aim to guide the generative process along the direction of the source to the target. Therefore, the present disclosure provides an intuitive modification to the classifier-free guidance for each time step in the (reverse) diffusion process, based on its geometric interpretation of extrapolating towards the noise prediction given a target caption.

Formally, recall the classifier-free guidance towards the caption c (Eq. 6) where c=c_{target} in the ROM problem setting). Instead of starting the guidance from an empty set Ø, example implementations of the present disclosure instead guide the generative sampling process starting from the reference text prompt c_{ref} as follows:

$${\hat{ε}}_{θ} ( {x}_{t} \vert c ) = {ε}_{θ} ( {x}_{t} \vert {c}_{ref} ) + s \cdot ( {ε}_{θ} ( {x}_{t} \vert c ) - {ε}_{θ} ( {x}_{t} \vert {c}_{ref} ) ) . \qquad ( 8 )$$

Intuitively, one can think of Eq. (8) as guiding the generative process along the direction towards the target expression from the referring expression on the joint (noisy) image-text embedding space, as illustrated in FIG. 3.

To align with the changes in the guidance direction, some example implementations can also set the input to the inpainting model as the original input image, instead of the masked image as in the original GLIDE. For example, one can roughly think of the original classifier-free guidance as generating a new object in a blank region (corresponding to the Ø caption). However, since the ROM setting includes additional semantic information about the referring region with c_{ref} in the ROM problem setting, conditioning on this knowledge is beneficial to the editing quality.

Example Localized Output Ranking with Context

Many existing works on text-guided generative models first synthesize a large number of samples and rank the generations using CLIP. Nichol et al. (GLIDE) suggests that CLIP re-ranking is not necessary when a model is trained with classifier-free guidance. However, in contrast to this suggestion, the present disclosure has empirically found that the generated images with higher rankings are perceptually better than the low-ranked images and therefore, some example implementations can re-apply the output ranking scheme.

Certain works propose to rank the final generated outputs with a pretrained CLIP model. However, these approaches perform ranking only on the masked region, which can sometimes lead the model to generate a plausible region by itself but does not harmonize with the unmasked regions well. Thus, some example implementations of the present disclosure propose to instead rank the final outputs with respect to the bounding box enlarged by a small enlargement ratio (e.g., ×1.3 as one example). This enables localized ranking that also considers the surrounding context.

### Example Dilated Mask Prediction

The main problem that arises when using an automatically generated segmentation mask is that the mask prediction can be inaccurate. In particular, the errors are much more critical when the mask does not cover the full object, compared to when the mask is covering the region larger than the object. Thus, some example implementations of the present disclosure employ a simple heuristic of enlarging the predicted segmentation mask with a dilation operator, one of morphological transformations, to ensure that the mask better covers the referred object. This problem was not an issue for previous text-guided inpainting approaches, since a user-generated mask almost always covers the full object.

### Example Experiments

### Example Implementation Details

The example experiments used PyTorch framework for implementing the proposed approach. Since some example implementations of the proposed framework do not require additional training, all results in this paper can be obtained with a single GPU (the example experiments used NVIDIA V100) or by simply using a hosted runtime on Colab. Also, the public GLIDE-inpainting model consists of two separate models: 64×64 inpainting diffusion model and 256×256 (inpainting-aware) upsampling model. In the example experiments, the proposed improvements are only applied to the 64×64 inpainting model. Following the setting in GLIDE, the example experiments used 100 diffusion steps in the inpainting model for fast sampling (instead of the full 1000 steps in DDPM), and 27 steps for the upsampling model. For guidance scale s, the example experiments found that the default setting of s=5 in the open-source GLIDE repository works well for the compared GLIDE baselines, but the proposed method typically works better for a larger scale of s=15.

### Example Comparisons

The example experiments compare the proposed framework with three baselines: 1) Blended-diffusion (denoted as ‘Blended’) and GLIDE with 2) CLIP guidance and 3) Classifier-Free (CF) guidance. Blended-diffusion is described at Avrahami et al., Blended diffusion for text-driven editing of natural images. arXiv: 2111.14818 (2021).

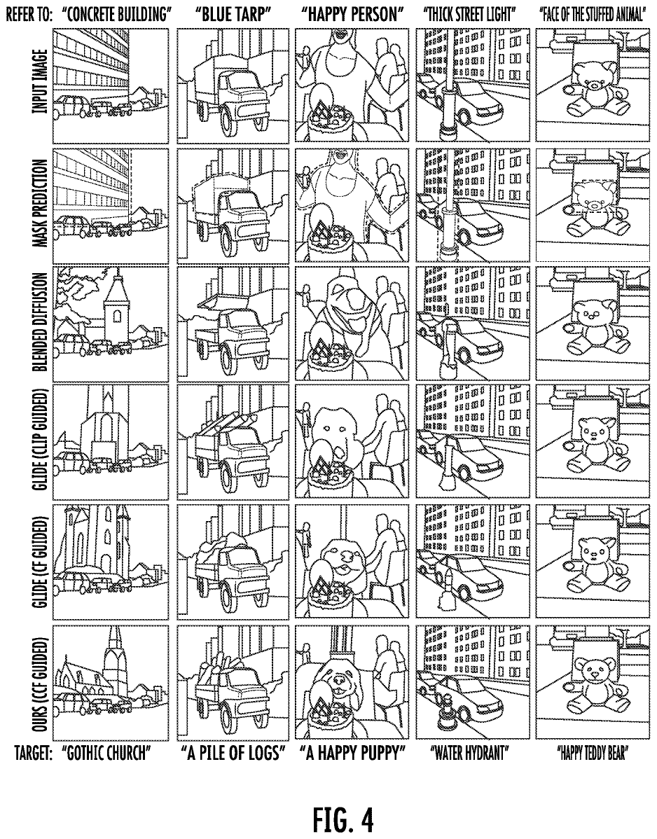

The example experiments use the images and captions from the PhraseCut dataset for the comparisons, but occasionally modify the referring captions to a more salient object (or stuff) for better visualizations on our manipulation settings. The example experiments manually give the target text prompts to demonstrate new and interesting edits. For the compared models, the user-given mask inputs are substituted with the prediction from MDETR (and dilated). The overall qualitative results are summarized in FIG. 4.

In particular, FIG. 4 illustrates a comparison between methods on text-guided image manipulation using images from PhraseCut dataset. All models use the same input mask given by the output of MDETR. The proposed conditional classifier-free guidance is able to make more visually pleasing edits that correctly follow the target text.

In general, the example experiments found that CLIP-guided approach is susceptible to making adversarial examples that fool the CLIP model. The Blended model is able to mitigate this issue by augmentations and generates high-quality edits, but sometimes shows imbalanced proportions between the masked region and the rest. Classifier-free guidance and the proposed conditional CF (CCF) guidance enables to remove CLIP during the diffusion steps and generates good-looking results most of the time, but the results using the proposed CCF guidance usually show more realistic images.

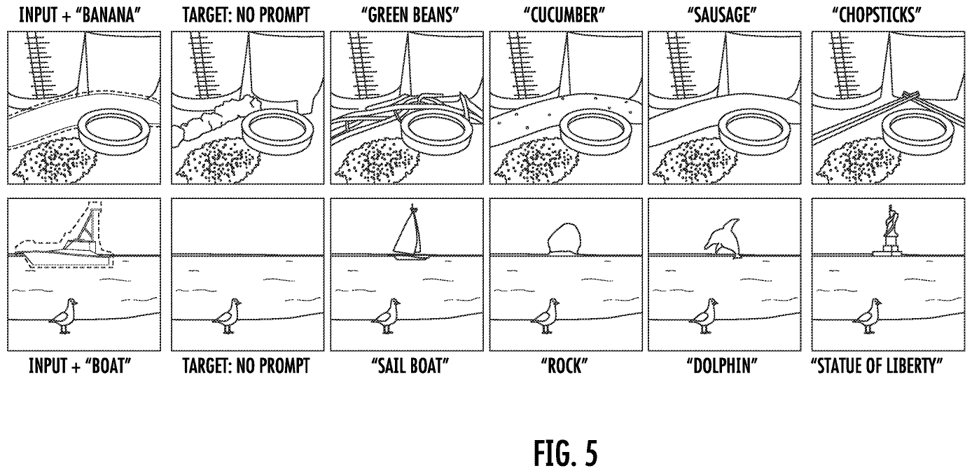

The example experiments also demonstrate different generations with respect to each target text prompt in FIG. 5. Note that when there is no target prompt, the model performs inpainting and fills in the masked region from the surrounding context. Specifically FIG. 5 shows qualitative example for diverse target text queries. The example experiments use the guidance scale s=15.0 for all methods. Interestingly, inpainting the bananas without any condition led to generating what looks like a shrimp tempura due to the dipping sauce next to it. The example experiments could also generate many interesting objects near the horizon.

### Example User Studies

For quantitative evaluation of the editing quality, the example experiments included a human subjective test on 20 sample outputs, compared with Blended and GLIDE (CLIP and CF-guided). In each testing case, the example experiments including showing the input image, the local region of interest, the target text, and 4 output edits including those generated by the proposed model. The order of the display is randomized, and each participant is asked to rank the 4 outputs. A total of 60 users participated in this study, and the aggregated results are shown in Table 1. The example experiments found that no single model absolutely wins over the other, since all models have strong generation capabilities and give plausible outputs. However, the proposed CCF-guided method shows the best average rank (best rank is 1, worst is 4), and the proposed algorithm has 54.4% of winning probability when compared with the second best method of Blended, and 58.4% against the most similar baseline, CF-guided GLIDE.

TABLE 1
User study results. The example experiments report the
average rank (1~4) and the winning probability of a method
in each row against the other models in each column.

| | Avg. | Winning prob. vs: | | | |
|---|---|---|---|---|---|
| Method | Rank _{↓} | Blend | G-CLIP | G-CF | Ours |
| Blended | 2.40 | — | 57.8% | 51.4% | 45.6% |
| GLIDE (CLIP-guided) | 2.82 | 42.2% | — | 46.6% | 34.2% |
| GLIDE (CF-guided) | 2.57 | 48.6% | 57.4% | — | 41.6% |
| Ours (CCF-guided) | 2.20 | 54.4% | 65.8% | 58.4% | — |

### Example Ablation Studies

The example experiments also analyzed the effects of each component of the proposed model in more detail.

### Effects of Guidance Direction

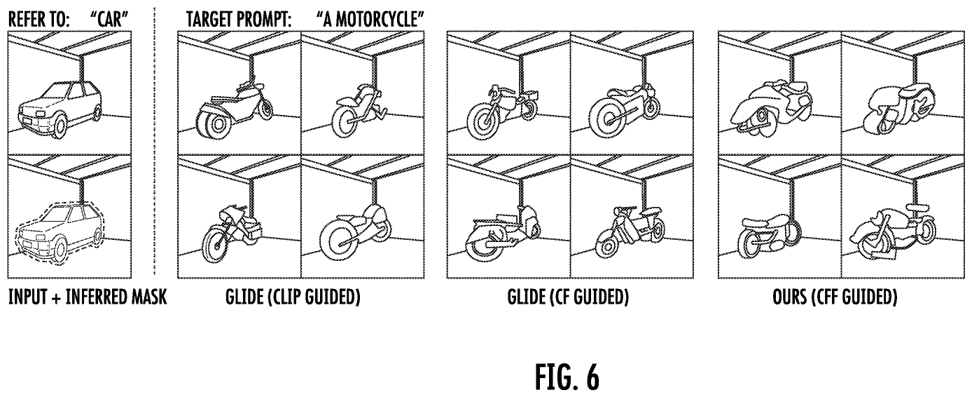

FIG. 6 shows the effects of different guidance methods. Four samples using different random seeds are shown for each guidance scheme. CLIP-guidance sometimes fails to generate the full object and shows only distinctive parts. While CF-guidance and Ours (CCF-guided) successfully synthesize the target object as a whole, the proposed models tend to more keep the characteristics of the original input image, red color, unless otherwise guided by the target prompt.

Given an input image and the segmentation mask estimated by MDETR, the example experiments compared the effects of the guidance direction of GLIDE in FIG. 3. Note that all results are obtained using exactly the same values of the pretrained parameters regardless of the guidance scheme. While all methods are capable of generating realistic outputs, the results provided by the proposed models tend to better keep the characteristics of the original image, while CF-guided GLIDE generates more diverse results. This is because CF-guided GLIDE model does not know the masked-out region which the proposed CCF-guided model knows, and each can be beneficial for its own use cases. Also, exploring which characteristic of the input image are preserved on the noise manifold of the diffusion process would make an interesting future work, which is out of scope of this paper.

### Effects of Localized Ranking

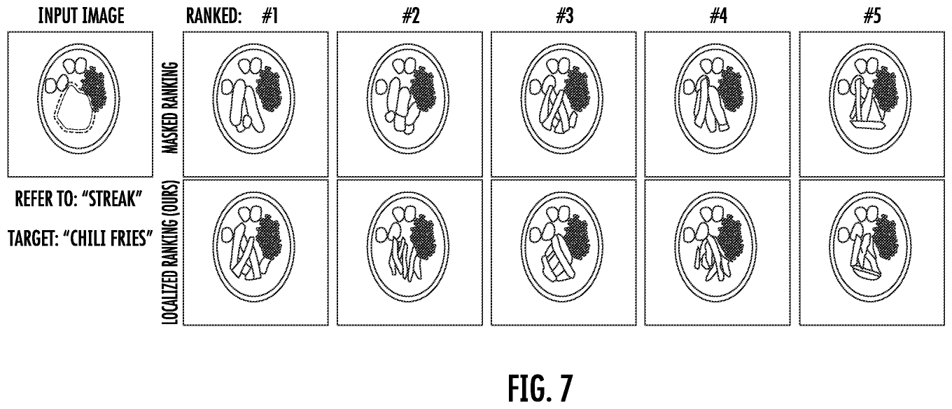

FIG. 7 shows effects of different ranking mechanisms. While the set of total generated images for the first and the second rows are the same, the masked ranking tends to prefer relatively thicker potato-like objects, whereas the top-ranked outputs generated by the proposed model are thinner and match the target text better.

A qualitative comparison between the ranking method in Blended and the proposed models is shown in FIG. 7. Since the outputs are generated using the same guidance scheme with the same random seed, the total set of output images should be identical. However, the top-ranked results for the proposed localized ranking technique are usually more realistic and harmonize with the nearby context better.

### Effects of Mask Dilation

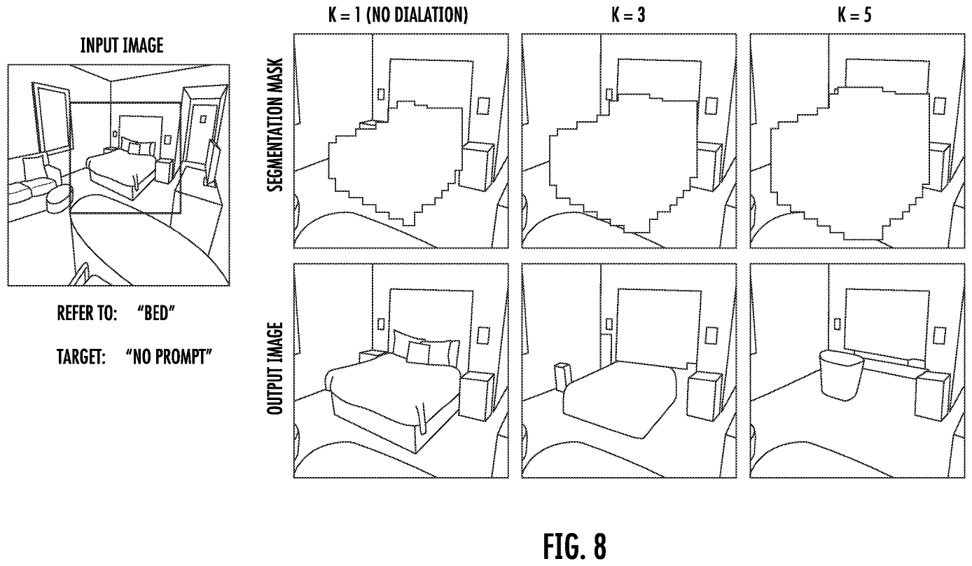

FIG. 8 shows the effects of mask dilation for inpainting (no target text). For k=1 or k=3, the model infers from the remaining white bed sheets or the bottom frame, which makes potentially unwanted artifacts. The example experiments show the enlarged region in the yellow box.

The example experiments show the effects of enlarging the intermediate segmentation mask with dilation in FIG. 8. If the predicted segmentation mask does not cover fully cover the object of interest, the remaining boundaries strongly affect how the model infers nearby context. This leads to generating a similar object category or some other unpleasing artifacts instead of removing the target object.

### Example Devices and Systems

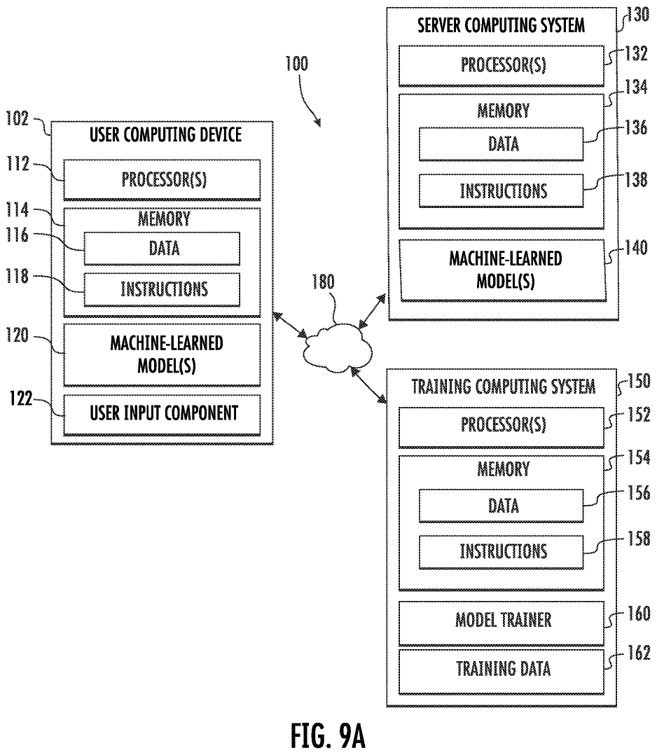

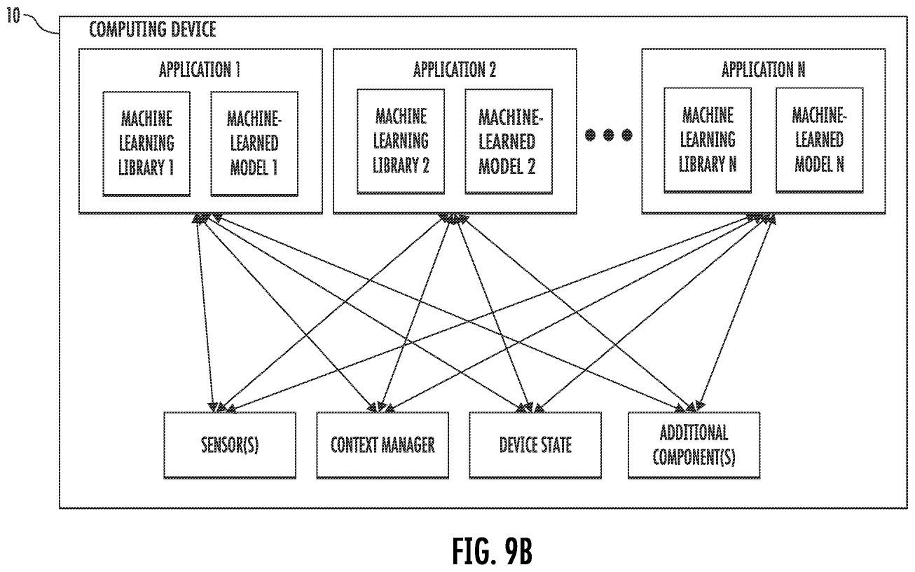

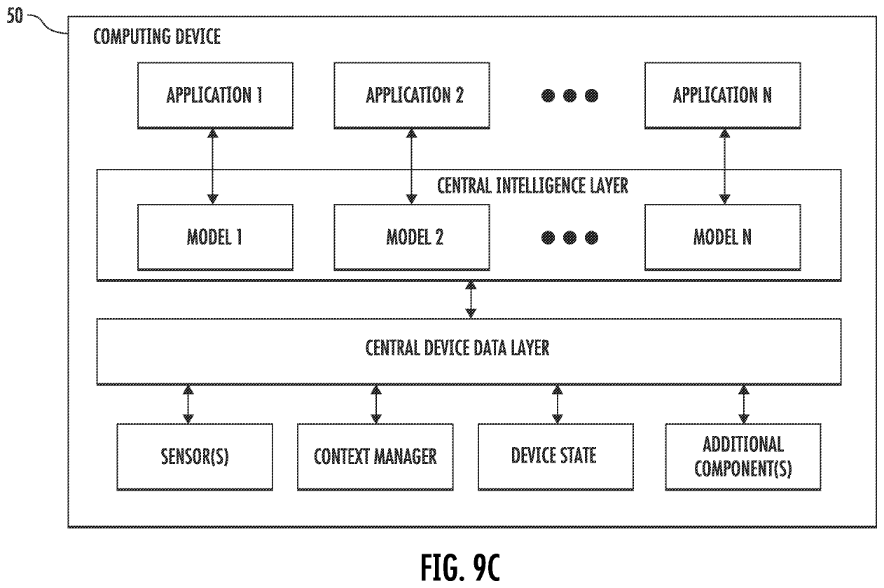

FIG. 9A depicts a block diagram of an example computing system 100 that performs image manipulation according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned image manipulations 120. For example, the machine-learned image manipulations 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned image manipulations 120 can be received from the server computing system 130 over network 180, stored in the user computing device memory 114, and then used or otherwise implemented by the one or more processors 112. In some implementations, the user computing device 102 can implement multiple parallel instances of a single machine-learned image manipulation 120 (e.g., to perform parallel image manipulation across multiple instances of input images).

Additionally or alternatively, one or more machine-learned image manipulations 140 can be included in or otherwise stored and implemented by the server computing system 130 that communicates with the user computing device 102 according to a client-server relationship. For example, the machine-learned image manipulations 140 can be implemented by the server computing system 140 as a portion of a web service (e.g., an image manipulation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned image manipulations 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned image manipulations 120 and/or 140 based on a set of training data 162. The training data 162 can include, for example, condition segmentation training data and/or conditional inpainting training data.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 9A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 9B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 9B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 9C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 9C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 9C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer system for image manipulation, the computer system comprising:
one or more processors;
a machine-learned image manipulation model configured to receive and process an input image and a natural language instruction to generate an edited image in accordance with the natural language instruction, wherein the natural language instruction comprises a reference portion that refers to a region of the input image and a target portion that describes a desired manipulation to be performed in the region of the input image; and
one or more non-transitory computer-readable media that collectively store instructions that, when executed by the one or more processors, cause the one or more processors to perform operations, the operations comprising:
obtaining the input image and the natural language instruction;
processing the input image and the natural language instruction with the machine-learned image manipulation model to generate the edited image, wherein the desired manipulation has been performed in the region of the input image to generate the edited image; and
providing the edited image as an output.

2. The computer system of claim 1, wherein:
the machine-learned image manipulation model comprises a machine-learned image segmentation model and a machine-learned inpainting model;
the machine-learned image segmentation model is configured to receive and process the input image and the reference portion of the natural language instruction to generate an image mask that identifies the region of the input image; and
the machine-learned inpainting model is configured to receive and process the input image, the image mask, and the target portion of the natural language instruction to generate the edited image.

3. The computer system of claim 2, wherein the machine-learned inpainting model comprises a conditional diffusion model.

4. The computer system of claim 2, wherein the operations further comprise dilating the image mask prior to processing the input image, the image mask, and the target portion of the natural language instruction with the machine-learned inpainting model.

5. The computer system of claim 2, wherein the machine-learned inpainting model is provided with conditional classifier-free guidance during generation of the edited image.

6. The computer system of claim 5, wherein the conditional classifier-free guidance guides the generation of the edited image toward the target portion of the natural language instruction from the reference portion of the natural language instruction.

7. The computer system of claim 5, wherein:
the machine-learned inpainting model comprises a diffusion model; and
the conditional classifier-free guidance perturbs additive noise of the diffusion model based on a probability associated with the reference portion of the natural language instruction.

8. The computer system of claim 2, wherein one or both of the machine-learned image segmentation model and the machine-learned inpainting model were pretrained prior to inclusion within the machine-learned image manipulation model and did not undergo additional training or fine-tuning after inclusion in the machine-learned image manipulation model.

9. The computer system claim 1, wherein processing the input image and the natural language instruction with the machine-learned image manipulation model to generate the edited image comprises:
processing, for a plurality of instances, the input image and the natural language instruction with the machine-learned image manipulation model to generate a plurality of candidate images;
generating a respective semantic similarity score for at least a portion of each of the plurality of candidate images relative to at least the target portion of the natural language instruction; and
selecting one of the candidate images to output as the edited image based at least in part the respective semantic similarity scores.

10. The computer system of claim 9, wherein generating the respective semantic similarity score for at least the portion of each of the plurality of candidate images comprises generating the respective semantic similarity score for a respective context-aware bounding box generated for each of the plurality of candidate images, wherein the respective context-aware bounding box for each of the plurality of candidate images is defined by enlarging by an enlargement factor a bounding box that includes the region of the input image.

11. A computer-implemented method for image manipulation, the method comprising
obtaining, by a computing system comprising one or more computing devices, an input image and a natural language instruction, wherein the natural language instruction comprises a reference portion that refers to a region of the input image and a target portion that describes a desired manipulation to be performed in the region of the input image;
processing, by the computing system, the input image and the natural language instruction with a machine-learned image manipulation model to generate an edited image, wherein the desired manipulation has been performed in the region of the input image to generate the edited image; and
providing, by the computing system, the edited image as an output.

12. The computer-implemented method of claim 11, wherein:
the machine-learned image manipulation model comprises a machine-learned image segmentation model and a machine-learned inpainting model;
the machine-learned image segmentation model is configured to receive and process the input image and the reference portion of the natural language instruction to generate an image mask that identifies the region of the input image; and
the machine-learned inpainting model is configured to receive and process the input image, the image mask, and the target portion of the natural language instruction to generate the edited image.

13. The computer-implemented method of claim 12, wherein the machine-learned inpainting model comprises a conditional diffusion model.

14. The computer-implemented method of claim 12, further comprising dilating, by the computing system, the image mask prior to processing the input image, the image mask, and the target portion of the natural language instruction with the machine-learned inpainting model.

15. The computer-implemented method of claim 12, further comprising providing the machine-learned inpainting model with conditional classifier-free guidance during generation of the edited image.

16. The computer-implemented method of claim 15, wherein the conditional classifier-free guidance guides the generation of the edited image toward the target portion of the natural language instruction from the reference portion of the natural language instruction.

17. The computer-implemented method of claim 15, wherein:
the machine-learned inpainting model comprises a diffusion model; and
the conditional classifier-free guidance perturbs additive noise of the diffusion model based on a probability associated with the reference portion of the natural language instruction.

18. The computer-implemented method of claim 11, wherein processing, by the computing system, the input image and the natural language instruction with the machine-learned image manipulation model to generate the edited image comprises:
processing, by the computing system, for a plurality of instances, the input image and the natural language instruction with the machine-learned image manipulation model to generate a plurality of candidate images;
generating, by the computing system, a respective semantic similarity score for at least a portion of each of the plurality of candidate images relative to at least the target portion of the natural language instruction; and
selecting, by the computing system, one of the candidate images to output as the edited image based at least in part the respective semantic similarity scores.

19. The computer system of claim 19, wherein generating, by the computing system, the respective semantic similarity score for at least the portion of each of the plurality of candidate images comprises generating, by the computing system, the respective semantic similarity score for a respective context-aware bounding box generated for each of the plurality of candidate images, wherein the respective context-aware bounding box for each of the plurality of candidate images is defined by enlarging by an enlargement factor a bounding box that includes the region of the input image.

20. One or more non-transitory computer-readable media that collectively store:
a machine-learned image manipulation model configured to receive and process an input image and a natural language instruction to generate an edited image in accordance with the natural language instruction, wherein the natural language instruction comprises a reference portion that refers to a region of the input image and a target portion that describes a desired manipulation to be performed in the region of the input image; and
instructions that, when executed by one or more processors, cause the one or more processors to perform operations, the operations comprising:
obtaining the input image and the natural language instruction;
processing the input image and the natural language instruction with the machine-learned image manipulation model to generate the edited image, wherein the desired manipulation has been performed in the region of the input image to generate the edited image; and
providing the edited image as an output.
